(19) United States
(12) Patent Application Publication
(10) Pub. No.: US 2005/0221878 A1
(43) Pub. Date: Oct. 6, 2005

(54) Method for entering a personalized communication profile into a communication user interface

(76) Inventors: James A. Van Bosch, Crystal Lake, IL (US); Michael A. Newell, Williams Bay, WI (US); Robert F. D'Avello, Lake Zurich, IL (US); Scott B. Davis, Walworth, WI (US); Nick J. Grivas, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 10/818,381

(22) Filed: Apr. 5, 2004

(51) Int. Cl. H04B 7/14

(52) U.S. Cl. 455/575.9

(57) ABSTRACT

An improved system and procedure for using user IDs to enter a personalized communication profile into a communication user interface, and preferably a vehicle-based communication user interface. In one embodiment, the user IDs correspond to switches, which may comprises switches within the vehicle or on devices in wireless communication with the vehicle, such as a key fob. The key fob code can either constitute the user ID or can be user to retrieve it from either the vehicle's head unit or a communications server. The switch may be dedicated to inputting the user ID, or may comprise switches also serving other functions, such as seat adjustment of the vehicle. The user ID can also be loaded using a display associated with the user interface. Additionally, the user ID may also be retrieved using a voice recognition module, which allows for loading of the communication profile without the necessity of pressing switches. The user profile retrieved using the user ID can either be stored at the head unit or the communication server.

The present application is related to the following co-pending, commonly assigned patent applications, which were filed concurrently herewith and incorporated by reference in their entirety:

Ser. No. ______, entitled “Selectively Enabling Communications at a User Interface Using a Profile,” attorney docket TC00167, filed concurrently herewith.

Ser. No. ______, entitled “Method for Enabling Communications Dependent on User Location, User-Specified Location, or Orientation,” attorney docket TC00168, filed concurrently herewith.

Ser. No. ______,entitled “Methods for Sending Messages Based on the Location of Mobile Users in a Communication Network,” attorney docket TC00169, filed concurrently herewith.

Ser. No. ______, entitled “Methods for Displaying a Route Traveled by Mobile Users in a Communication Network,” attorney docket TC00170, filed concurrently herewith.

Ser. No. ______,entitled “Conversion of Calls from an Ad Hoc Communication Network,” attorney docket TC00172, filed concurrently herewith.

Ser. No. ______, entitled “Methods and Systems for Controlling Communications in an Ad Hoc Communication Network,” attorney docket TC00174, filed concurrently herewith.

Ser. No. ______, entitled “Methods for Controlling Processing of Inputs to a Vehicle Wireless Communication Interface,” attorney docket TC00175, filed concurrently herewith.

Ser. No. ______, entitled “Methods for Controlling Processing of Outputs to a Vehicle Wireless Communication Interface,” attorney docket TC00176, filed concurrently herewith.

Ser. No. ______, entitled “Programmable Foot Switch Useable in a Communications User Interface in a Vehicle,” attorney docket TC00177, filed concurrently herewith.

### FIELD OF THE INVENTION

This invention relates to systems and methods for entering a personalized communication profile into a communication user interface, and preferably a vehicle-based communication user interface.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Star™ is a well-known communication system currently employed in vehicles, and allows vehicle occupants to establish a telephone call with others (such as a service center) by activating a switch.

Communications within the vehicle can be tailored to suit user preferences. For example, a service center may access and retrieve a user profile when a user in a vehicle attempts to communicate with the service center. However, such existing communication systems lack flexibility to tailor group communications and other ad hoc communications. For instance, existing approaches depend heavily on establishing communications from one end of a communication (namely, the service center) and do not provide sufficient means for all parties to dynamically and immediately apply user profiles. This lack of flexibility may prohibit users from communicating as freely as they might wish.

In sum, it is desired for a user to be able to easily enter his profile into a communication system, so that his communication preferences can be immediately applied. This disclosure presents several different means for doing this.

It is, therefore, desirable to provide an improved procedure for entering a personalized communication profile into a communication user interface, and preferably a vehicle-based communication user interface.

### BRIEF DESCRIPTION OF THE DRAWINGS

FIG. 1 is a block diagram of a wireless vehicular communications system;

FIG. 2 is a block diagram of a control system for a vehicular wireless communications system;

FIG. 3 is diagram illustrating a vehicle having switches for sending a user ID to a head unit of a vehicle;

FIG. 4 is a block diagram of a control system useable with the vehicle of FIG. 3;

FIGS. 5a, 5b is a diagram illustrating a display in a vehicle's user interface for associating user IDs to particular switches;

FIG. 6 illustrates a fey fob for wirelessly sending a user ID to the head unit in the vehicle;

FIG. 7 is a block diagram illustrating a control system useable with the key fob of FIG. 6;

FIG. 8 is a block diagram illustrating a control system which allows the user ID to be activated by voice recognition; and

FIG. 9 illustrates a display in the vehicle's user interface for entering a user ID.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is an improved system and method for using user IDs to enter a personalized communication profile into a communication user interface, and preferably a vehicle-based communication user interface. In one embodiment, the user IDs correspond to switches, which may comprises switches within the vehicle or on devices in wireless communication with the vehicle, such as a key fob. The key fob code can either constitute the user ID or can be used to retrieve it from either the vehicle's head unit or a communications server. The switch may be dedicated to inputting the user ID, or may comprise switches also serving other functions, such as seat adjustment of the vehicle. The user ID can also be loaded using a display associated with the user interface. Additionally, the user ID may also be retrieved using a voice recognition module, which allows for loading of the communication profile without the necessity of pressing switches. The user profile retrieved using the user ID can either be stored at in a vehicle or a communication server.

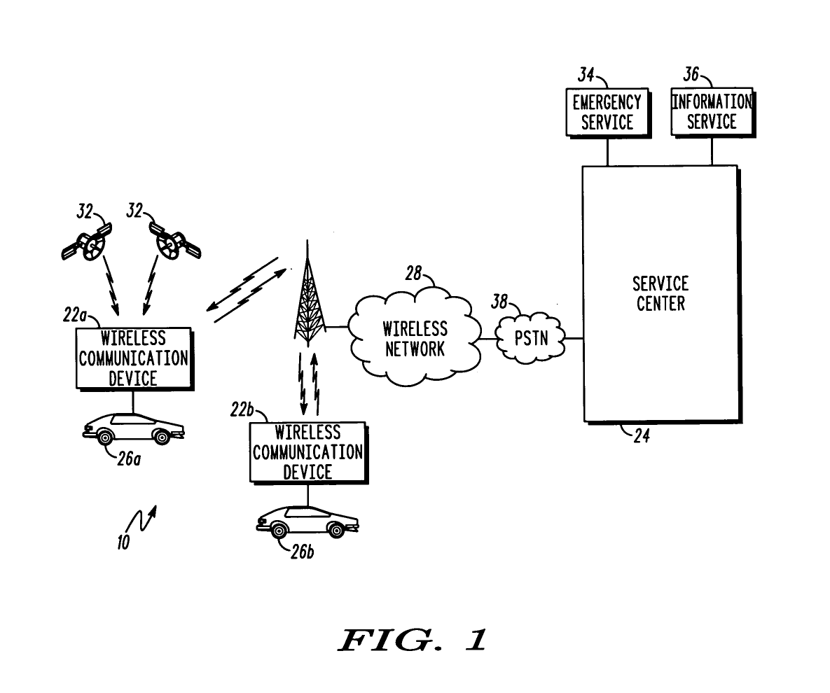

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of sending and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, either network may be coupled to a public switched telephone network (PSTN) 38, the Internet, or other communication network on route to a server 24, which ultimately acts as the host for communications on the communication system 10 and may comprise a communications server. As well as administering communications between vehicles 26 wirelessly connected to the system, the server 24 can be part of a service center that provides other services to the vehicles 26, such as emergency services 34 or other information services 36 (such as restaurant services, directory assistance, etc.).

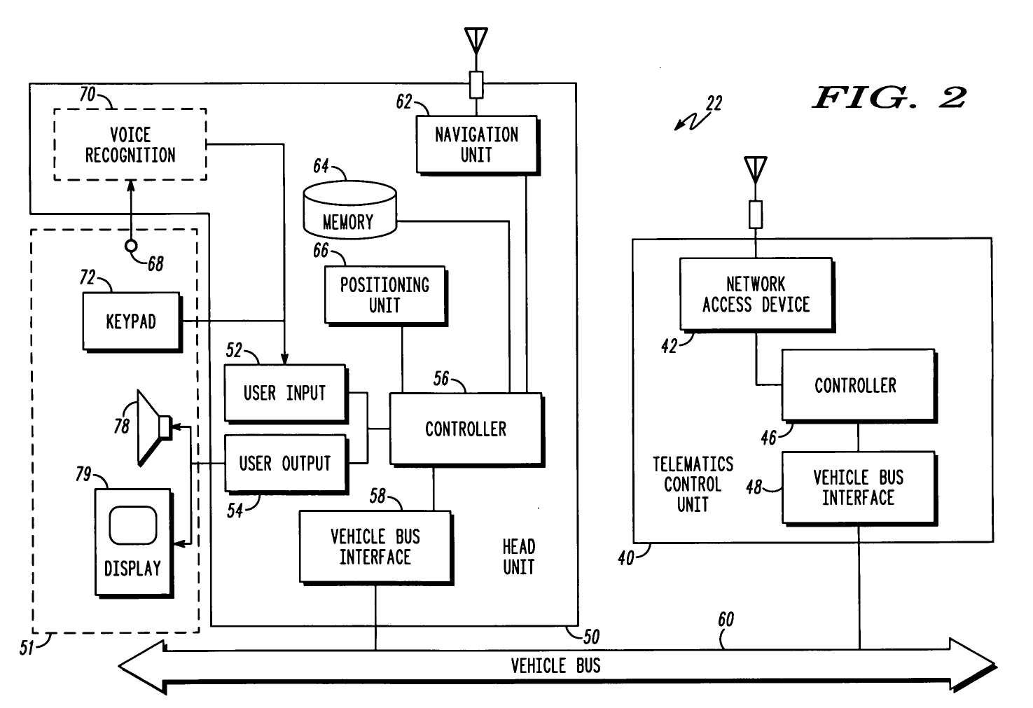

Further details of a typical wireless communications device 22 as employed in a vehicle 26 are shown in FIG. 2. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 (such as a push-to-talk button) or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, a user in the second vehicle 26b can, in like fashion, communicate back to the first vehicle 26a, with the speaker's voice being heard on speaker(s) 78 in the first vehicle. Or, an occupant in the first vehicle 26a can call the server 24 to receive services. Additionally, such a system 10 can have utility outside of the context of vehicle-based applications, and specifically can have utility with respect to other portable devices (cell phones, personal data assistants (PDAs), etc.). The use of the system in the context of vehicular communications is therefore merely exemplary.

Before discussing methods and system for entering a user's communication profile into the head unit 50 of a vehicle using a user ID, it should first be noted that the user profile can ultimately be stored either within the head unit 50 at the vehicle (e.g., at memory 64), or at the server 24 comprising the service center. In either case, the user's profile is stored along with the user's user ID, such that when the user ID is sent to the location where the user profile is stored, the profile can be queried and uploaded into the head unit appropriately to preferentially set the user's communication settings. This provides differing flexibilities to the user. For example, if a user normally drives only a particular vehicle, it may be sufficient to merely store the user profile in the memory 64 within the head unit 50 of the vehicle. However, if the user wishes to later drive a different vehicle not normally driven by the user, and if that vehicle is in communication with the system 10 and contains its own head unit 50 and user interface 51, storage of the user profile at the server 24 is beneficial, as it allows the user to personalize communication within that “foreign” vehicle through the use of his user ID. If the user profile is stored at the server 24, the user ID will be sent from the head unit 40, to the vehicle bus 60, to the telematics control unit 40, and off site to the server 24. The user profile is then retrieved and proceeds in reverse fashion back to the head unit, where it is stored in memory 64 and queried as appropriate by the controller 56. Thereafter, the controller 56 then uses the user profile to process user communication inputs and outputs in accordance with the user preferences in the user profile. When the user profile is stored in the memory 64 in the first instance, sending the user ID to the head unit 50 constitutes merely retrieving the user profile from the memory 64 itself and/or informing the controller which user ID is to be queried and utilized from the memory 64.

From this point forward, the concept of retrieving the user profile using a user ID should be understood as referring either to retrieval from the server 24 or the head unit 50.

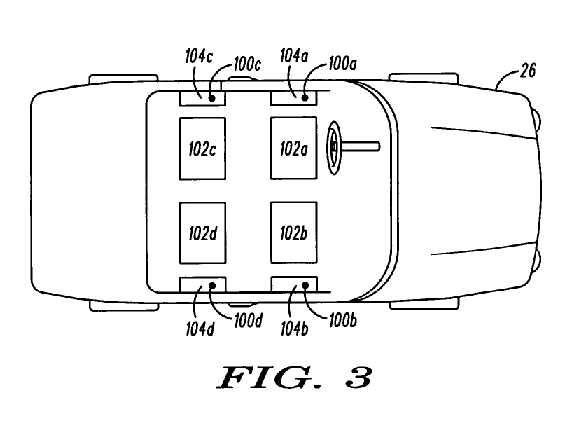

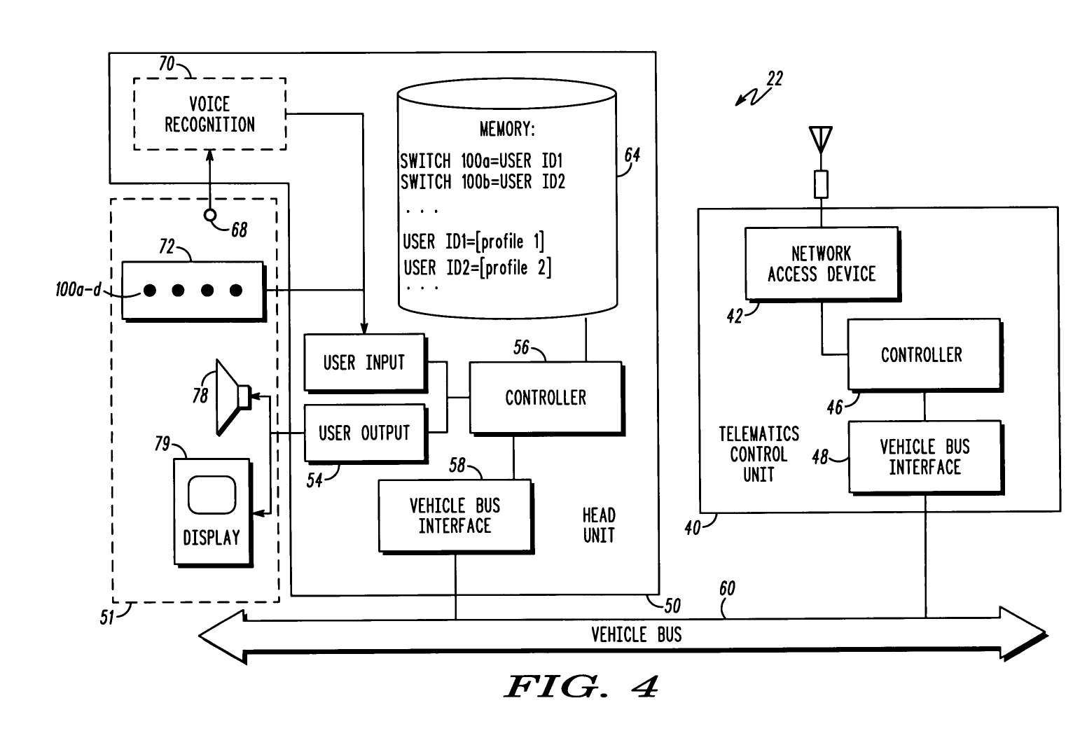

FIGS. 3 and 4 further illustrate how a user can enter his user ID into the system to retrieve his user profile. FIG. 3 illustrates an idealized top view of a vehicle 26 showing the seating positions of four vehicle occupants 102a-d. In this embodiment, the user interface 51 incorporates switches 100a-d (part of keypad 72) for each vehicle occupant. Switches 100a-d may comprise many different types of switches, and may be incorporated into a particular occupant's armrest 104a-d (as shown), or elsewhere near to the occupant such as on the occupant's door, on the dashboard or seat in front of the occupant, or on the bottom or side of the occupant's seat. The switches 100a-d may be dedicated switches for the sole purpose and sending a user ID, or may also comprise switches or buttons having additional functionalities, such as push-to-talk buttons, seat adjustment switches, door or window controls, etc. In a preferred embodiment, the switches comprise vehicle adjustment memory switches such as seat adjustment switches.

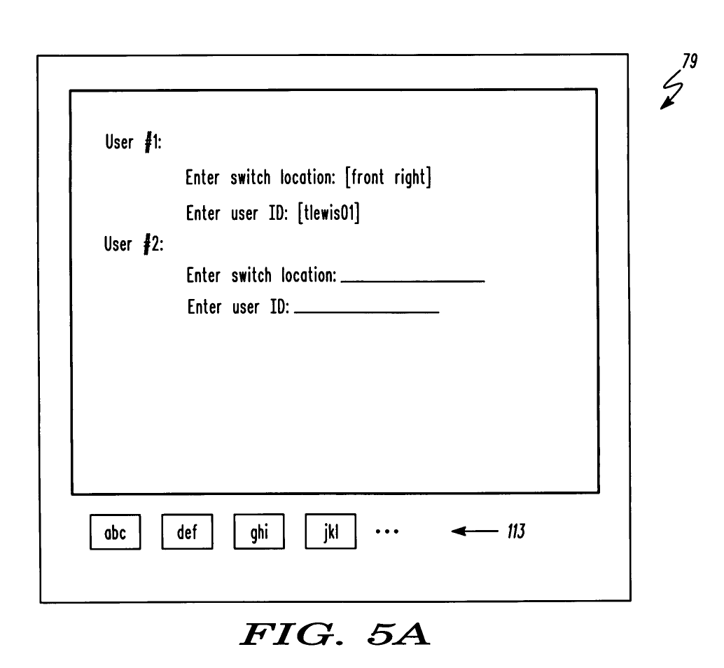

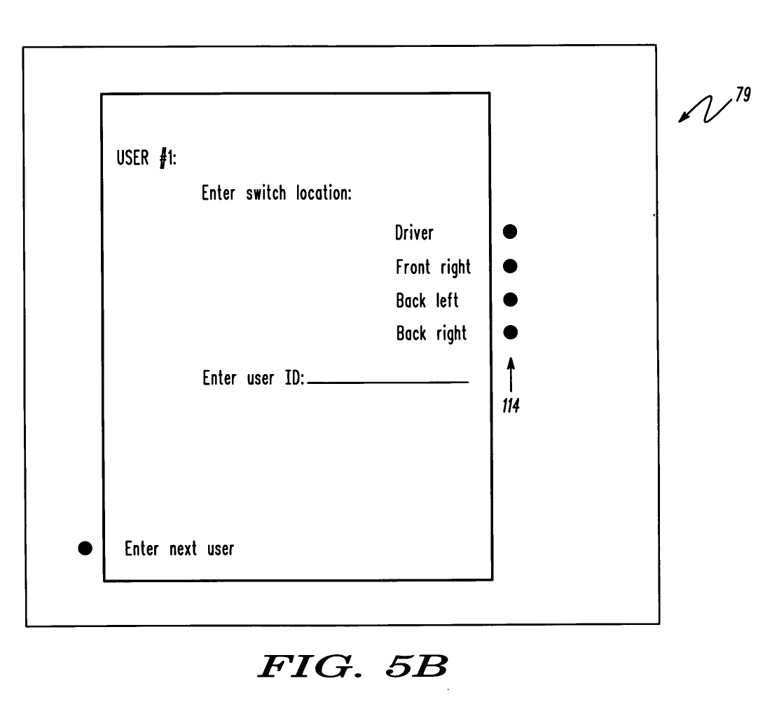

Regardless, the switches 100a-d corresponds to a particular user, and hence to a particular user's ID, and the switches 100a-d and corresponding user IDs are associated and stored in memory 64. Such association between the switches 100a-d and a particular user ID can be established by the users prior to traveling, and may be done using the display 79 in the vehicle's user interface. FIG. 5a shows one method in the form of a menu provided on the display 79. In this example, the various occupants in the first vehicle can enter a switch 100a-d position and their user ID by typing it in using switches 113 on the user interface 51, which in this example would be similar to schemes used to enter names and numbers into a cell phone. An alternative scheme is shown in FIG. 5b, in which selection switches 114 are used to select a particular switch 100a-d. The disclosed schemes of FIGS. 5a and b are illustrative.

Once this switch/user ID association is made, the switches 100a-d may be pressed at an appropriate time to send its corresponding user ID (or simply the switches dedicated code, which may itself constitute the user ID) to the controller 56 or to the server 24 to retrieve the corresponding user profile, such as is illustrated in FIG. 4 in which the user profile is stored in the head unit. Such an appropriate time may be before a user starts the vehicle, or may constitute a particular time in the operational software in the head unit 50. For example, when the head unit 51 initializes after the vehicle is turned on, the user may be prompted by the display 79 with a message “enter user ID,” at which time the user may press the appropriate switch 100a-d to retrieve his communication user profile.

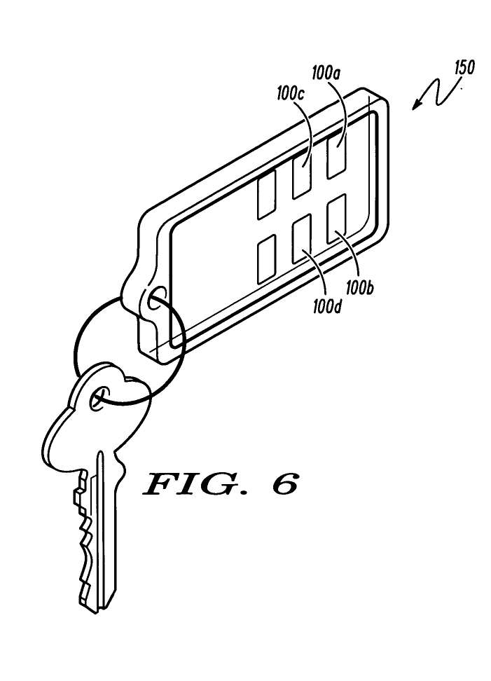

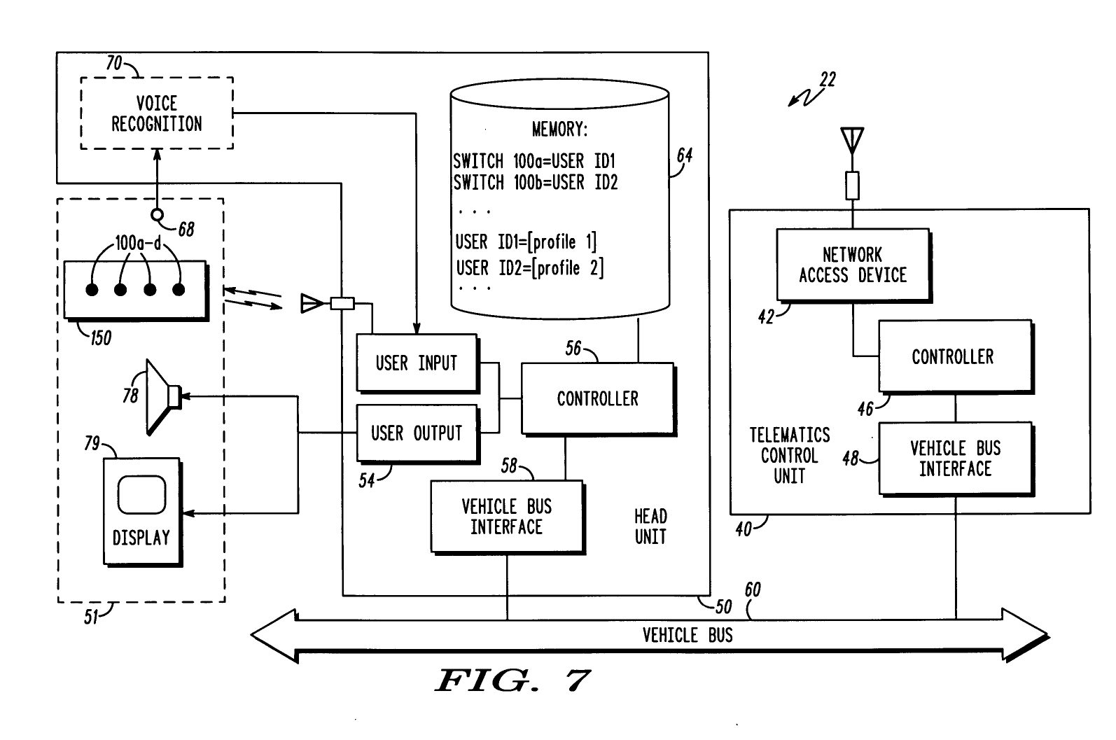

Switches 100a-d need not be associated with switches on the vehicle. Instead, they can be located on portable wireless devices capable of communicating with the head unit 50 of the vehicle. Such a device preferably constitutes a “key fob” 150 of the type typically used to unlock the vehicle's doors or trunk, and which is illustrated in FIG. 6. As one skilled in the art understands, each switch of the key fob 150 wirelessly outputs a unique key fob code interpretable by the head unit 50. The unique key fob codes output by switches 100a-d on the key fob 150 can be used to retrieve the user ID to the head unit 50 to cause a user's user profile to be retrieved as with the embodiment of FIGS. 3-4.

This can be accomplished in a number of ways. The switches 100a-d may constitute switches dedicated to retrieval of the user profile, or may constitute switches which also (perhaps simultaneously) perform other functions, such as unlocking the doors. Moreover, the key fob code for each switch 100a-d can itself constitute the user ID, or can be associated with a user ID stored at the head unit 50 or server 24 using associative techniques such as those illustrative above. If the key fob code is transmitted to the server 24 and associated with the user ID there, the user ID is either used to retrieve the user profile from the server 24, or the user ID can be transferred back from the server 24 to the head unit 50 to retrieve the user profile from there.

As noted earlier, other portable wireless devices may have similar switches that could be used to wirelessly transmit the user ID to the head unit (or the server 24). For example, personal data assistants (PDA), cell phones, laptop computers, or like devices can be used as well.

Moreover, in a further embodiment, the user ID may be accessed and used for a user based on an object carried by the particular user. For instance, in one embodiment, a vehicle is equipped with a short range detection system and a user is equipped with a card, key chain, or other object that is detectable by the short range detection system. As the user approaches the vehicle, the short range detection system is capable of detecting the presence of the user within predetermined vicinity and unlocks the doors and/or starts the vehicle's engine. After powering up the head unit 50, in this embodiment, the system would then cause the head unit 50 to access and set a user ID associated with the approaching user. In other words, a vehicle in this case would recognize a user approaching the vehicle based on an object being carried by the user.

In another embodiment, the user ID may be accessed and used for a user based on a coded vehicle key held by a particular user. For instance, in one embodiment, a vehicle is equipped with an ignition system that is capable of receiving a coded key. As the user inserts the coded key into the ignition system, the ignition system along with the user interface is capable of detecting the user through a resistance in the key. After powering up the head unit 50, in this embodiment, the system would then cause the head unit 50 to access and set a user ID associated with the user having the coded key. In other words, a vehicle in this case would recognize a user based on the use of a coded key.

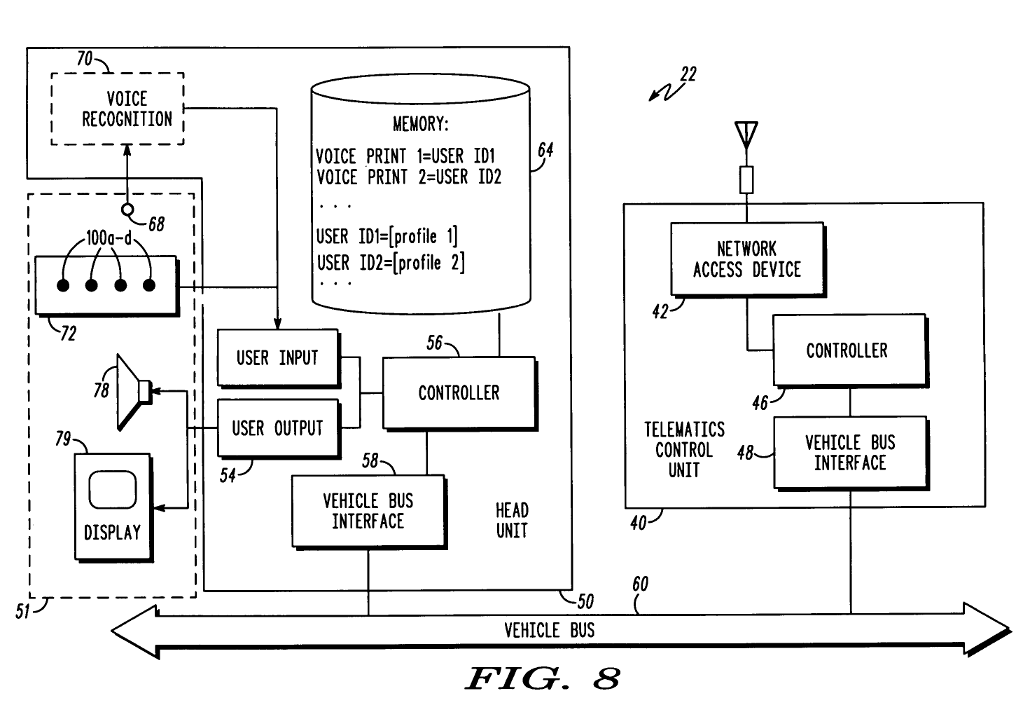

Instead of pressing switches, the user profile can be retrieved to the head unit 50 with the assistance of voice recognition module 70 (see FIG. 2). In this regard, voice recognition module 70 (which also may constitute part of the controller 56) is employed to process a received voice in the vehicle and to match it to pre-stored voice prints stored in the voice recognition module 70, which can be entered and stored by the occupants at an earlier time (e.g., in memory 64). Many such voice recognition algorithms exist and are useable in the head unit 50, as one skilled in the art will appreciate. When a voice recognition module 70 is employed, communications are made more convenient, as an occupant in the vehicle can speak his user ID or can otherwise say something recognizable by the system which is associated with the user ID, similar to that described above, and as shown in FIG. 8. Of course, in this voice recognition embodiment, the user ID and/or user profile can be stored at the server 24 as well as within the head unit 50.

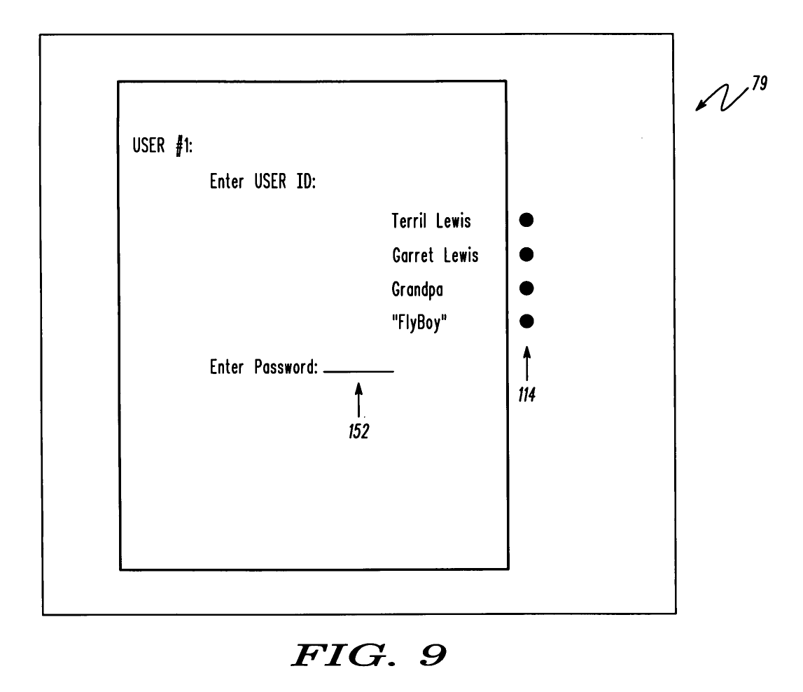

An alternative embodiment for retrieving a user's user profile is shown in FIG. 9, and involves the use of the display 79 in the user interface 51 of the head unit. In this embodiment, the head unit displays a list of user IDs, perhaps which have been pre-stored within the head unit 50 or the server 24. The display prompts the user to select his user profile using, for example, switches 114. Optionally, the display 79 may require the user to input a password 152, which can independently be verified either at the head unit 50 or the server 24. Either way, once the user ID is input, the user profile is retrieved either from the head unit or the server to tailor the user's communication options as noted above.

While largely described with respect to improving communications within vehicles, one skilled in the art with the benefit of this disclosure will understand that many of the concepts disclosed herein could have applicability to other portable communicative user interfaces not contained within vehicles, such as cell phones, personal data assistants (PDAs), portable computers, etc., what can be referred to collectively as portable communication devices.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method for entering a user communication profile into a user interface in a vehicle to enable a user to wirelessly communicate with a server using the user interface, comprising:
pressing one of a plurality of switches, each associated with a unique first code, to send a first code to the user interface in the vehicle; and
using the first code to query the server to download a user profile corresponding to the first code from the server to adjust communication options at the user interface.

2. The method of claim 1, wherein the plurality of switches are located in or on the vehicle.

3. The method of claim 2, wherein the plurality of switches comprises vehicle adjustment memory switches.

4. The method of claim 3, wherein the vehicle memory adjustment switches adjust the seats in the vehicle.

5. The method of claim 1, wherein the plurality of switches are located on the user interface.

6. The method of claim 1, wherein the each of the plurality of switches is located on a device in wireless communication with the user interface.

7. The method of claim 6, wherein the device comprises a key fob, a phone, a personal data assistant, or a portable computer.

8. The method of claim 6, wherein the device comprises a key fob, and the first code comprises a key fob code.

9. The method of claim 8, wherein the key fob code is associated with a second code at the server.

10. A method for entering a user communication profile into a user interface in a vehicle to enable a user to wirelessly communicate with a server using the user interface, comprising:
pressing one of a plurality of switches, each associated with a unique first code, to send a first code to the user interface in the vehicle; and
using the first code to load a user profile corresponding to the first code from a memory module in the vehicle coupled to the user interface to adjust communication options at the user interface.

11. The method of claim 10, wherein the plurality of switches are located in or on the vehicle.

12. The method of claim 11, wherein the plurality of switches comprises vehicle adjustment memory switches.

13. The method of claim 12, wherein the vehicle memory adjustment switches adjust the seats in the vehicle.

14. The method of claim 10, wherein the plurality of switches are located on the user interface.

15. The method of claim 10, wherein the each of the plurality of switches is located on a device in wireless communication with the user interface.

16. The method of claim 15, wherein the device comprises a key fob, a phone, a personal data assistant, or a portable computer.

17. The method of claim 15, wherein the device comprises a key fob and the first code comprises a key fob code.

18. The method of claim 17, wherein the key fob code is associated with a second code at the memory module.

19. A method for entering a user communication profile through a user interface in a vehicle to enable a user to wirelessly communicate with a server using the user interface, comprising:
receiving a first code through the user interface in the vehicle;
using the first code to query the server to download a user profile corresponding to the first code from the server to adjust communication options at the user interface; and
programming a push-to-talk button on the user interface for engaging in voice communications based on the user profile downloaded from the server.

20. The method of claim 19, wherein the first code is received from a selectable option on the user interface.

21. The method of claim 19, wherein the user interface is configured to wirelessly receive signals from a device, and wherein the step of receiving the first code through the user interface comprises having the user select a button on the device and the user interface associates the user with the user's first code.

22. The method of claim 21, wherein the device is a key fob.

23. The method of claim 19, wherein the step of receiving the first code further comprises receiving a password, and wherein the password is authenticated by either the server or the user interface prior to downloading the user profile.

24. The method of claim 19, wherein the user interface is configured to recognize speech, and wherein the step of receiving the first code through the user interface comprises having the user speak the first code.

25. The method of claim 19, wherein the user interface recognizes the user's voice, and wherein the step of receiving the first code through the user interface comprises having the user speak and the user interface associates the user's voice with the user's first code.

26. The method of claim 19, wherein the step of receiving the first code through the user interface comprises selecting an option on the user interface to send one of a plurality of first codes from the user interface.

27. The method of claim 19, wherein the user interface in the vehicle includes a short range detection system.

28. The method of claim 27, wherein the step of receiving the first code through the user interface comprises detecting a presence of the user within a predetermined range of the vehicle and, upon detecting the presence of the user within the predetermined range, the user interface associates the user with the user's first code.

29. A method for entering a user communication profile through a user interface in a vehicle to enable a user to wirelessly communicate with a server using the user interface, comprising:
receiving a first code through the user interface in the vehicle;
using the first code to load a user profile corresponding to the first code from a memory module in the vehicle coupled to the user interface to adjust communication options at the user interface; and
programming a push-to-talk button on the user interface for engaging in voice communications based on the user profile loaded from the memory module.

30. The method of claim 29, wherein the first code is received from a selectable option on the user interface.

31. The method of claim 29, wherein the user interface is configured to wirelessly receive signals from a device, and wherein the step of receiving the first code through the user interface comprising having the user select a button on the device and the user interface associates the user with the user's first code.

32. The method of claim 31, wherein the device is a key fob.

33. The method of claim 29, wherein the step of receiving the first code further comprises receiving a password, and wherein the password is authenticated by either the server or the user interface prior to downloading the user profile.

34. The method of claim 29, wherein the user interface is configured to recognize speech, and wherein the step of receiving the first code through the user interface comprises having the user speak the first code.

35. The method of claim 29, wherein the user interface recognizes the user's voice, and wherein the step of receiving the first code through the user interface comprises having the user speak and the user interface associates the user's voice with the user's first code.

36. The method of claim 29, wherein the step of receiving a first code through the user interface comprises selecting an option on the user interface to send one of a plurality of first codes from the user interface.

37. The method of claim 29, wherein the user interface in the vehicle includes a short range detection system.

38. The method of claim 37, wherein the step of receiving the first code through the user interface comprises detecting a presence of the user within a predetermined range of the vehicle and, upon detection of the presence of the user within the predetermined range, the user interface associates the user with the user's first code.
